(19) United States
(12) Patent Application Publication
(10) Pub. No.: US 2008/0231908 A1
(43) Pub. Date: Sep. 25, 2008

(54) Methods and systems for classifying and prioritizing incoming facsimiles

(75) Inventors: Peter Hartman, (US); Laurence Parsons, (US)

Correspondence Address: PILLSBURY WINTHROP SHAW PITTMAN, LLP;XEROX CORPORATION, P.O. BOX 10500, MCLEAN, VA, 22102, US

(73) Assignee: Xerox Corporation, Stamford, CT (US)

(21) Appl. No.: 11/723,375

(22) Filed: Mar. 19, 2007

(51) Int. Cl. H04N 1/00

(52) U.S. Cl. 358/400

(57) ABSTRACT

A method is provided for classifying and prioritizing facsimiles comprising: accepting a facsimile comprising image data; classifying the facsimile in accordance with a predetermined classification scheme based on the data comprising the facsimile; determining, based on the classification, at least one characteristic of an output of the facsimile; and outputting the facsimile in a user readable format. Also provided is a system for classifying and prioritizing facsimiles comprising: a machine for accepting a facsimile comprising image data; a processor for classifying the facsimile in accordance with a predetermined classification scheme based on the data comprising the facsimile, and determining, based on the classification, at least one characteristic of an output of the facsimile; and a device for outputting the facsimile in a user readable. The output of facsimile may be classified by selecting a different type of media, selecting a different color media, printing or marking at least part of the facsimile in a different ink color, printing or marking the print output of the facsimile with a decoration or annotation, altering image data, or a combination thereof.

### FIELD

This invention relates to methods and systems for classifying and prioritizing incoming facsimiles.

### BACKGROUND

A typical printed facsimile is nearly identical to the original document. The receiving facsimile machine may print supplemental information on the facsimile, such as the date/time the facsimile was received, the sender's telephone number, and page numbers of the facsimile. However, current fax users have no simple way of determining the fax priority without first reading the content of the facsimile.

Thus, the inventors have identified a need for an improved way for classifying and prioritizing facsimiles.

### SUMMARY

A method is provided for classifying and prioritizing facsimiles comprising: accepting a facsimile comprising image data; classifying the facsimile in accordance with a predetermined classification scheme based on the data comprising the facsimile; determining, based on the classification, at least one characteristic of an output of the facsimile; and outputting the facsimile in a user readable format.

Also provided is a system for classifying and prioritizing facsimiles comprising: a machine for accepting a facsimile comprising image data; a processor for classifying the facsimile in accordance with a predetermined classification scheme based on the data comprising the facsimile, and determining, based on the classification, at least one characteristic of an output of the facsimile; and a device for outputting the facsimile in a user readable.

The output of the facsimile may be classified by altering the image data of the facsimile, altering the print output of the facsimile, or both. In a first embodiment, the altering the image data of the facsimile comprises generating and/or altering image data corresponding to a color, decoration, annotation, or combination thereof. In a second embodiment, the altering the print output of the facsimile comprises: selecting a different media for the print output of facsimile, selecting a different color media the print output of facsimile, printing or marking at least part of the print output of the facsimile in a different ink or toner color, printing or marking the print output of facsimile with a decoration or annotation, or a combination thereof. The decoration or annotation may comprise: a geometric shape, a band covering an edge or corner of the facsimile, a border around at least part of the facsimile, a custom icon, text, or a combination thereof.

In one embodiment, the data may comprise: the telephone number of a sending machine, email address of the sender, sender-supplied information, manufacturer or user defined-fields, or a combination thereof.

In another embodiment, the classification of the facsimile may be based on a priority of the facsimile. The priority may be selected by the sender, determined by a sending machine, determined by the receiving a machine, determined by matching the sender's telephone number or email address with assigned priorities, or a combination thereof.

Other objects, features, and advantages of one or more embodiments of the present invention will seem apparent from the following detailed description, and accompanying drawings, and the appended claims.

### BRIEF DESCRIPTION OF THE DRAWINGS

Embodiments of the present invention will now be disclosed, by way of example only, with reference to the accompanying schematic drawings in which corresponding reference symbols indicate corresponding parts, in which

FIG. 1 shows a system for transmitting a facsimile in accordance with an embodiment of the present invention; and

FIG. 2 shows how the print output of the facsimile may be altered in accordance with an embodiment of the present invention.

### DETAILED DESCRIPTION

Faxing is a telecommunications technology used to transfer copies of documents, over a telecommunications network, such as telephone network, cell-phone system, computer network (e.g., LAN, WAN, Internet) or a combination of aspects thereof. A fax or facsimile is any copy or reproduction of a document by faxing. The International Telecommunication Union Telecommunications Standardization Sector (ITU-T, formerly CCITT), based in Geneva Switzerland, coordinates telecommunications standards and protocols, including facsimile transmission. Embodiments of the invention contemplate facsimile transmissions in accordance with ITU-T or other standards organizations.

Fax or facsimile machines disclosed herein are merely exemplary and embodiments of the invention may be practiced with other systems having fax capabilities (e.g., a computer, a fax server/gateway, PDA, cell-phone, etc.). In addition, the fax machine may be part of another machine or device such as a multifunctional device (MFD) that includes multiple capabilities such as printing, scanning, faxing, and/or copying. Other machines and devices could also be used so long as they are capable of handling electronic image data.

Some embodiments may contemplate use with computer based faxing (also referred to as desktop faxing, Internet faxing, “mail to fax,” “fax to mail,” or efaxing). Computer based faxing involves using a fax server/gateway and an email server on the Internet to convert between faxes and email, for example, as disclosed in U.S. Pat. Nos. 6,424,266 and 6,020,980, herein incorporated by reference. The fax server may have a directory or other means for correlating fax numbers and/or recipients with email addresses. When a facsimile is received by the fax server, the fax server generates an email message to the receiver, including the image data of the facsimile. The image data of the facsimile may be embedded into the email message itself or transferred as an electronic attachment to the email message (e.g., a PDF file).

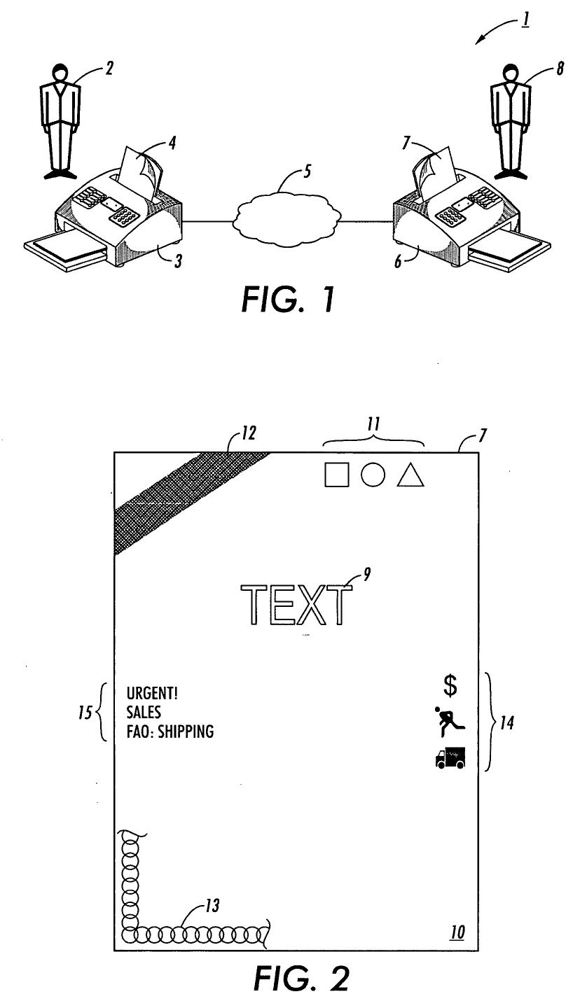

FIG. 1 shows a system 1 for transmitting and receiving facsimiles in accordance with an exemplary embodiment. A person (the sender) 2 uses a machine 3 to scan documents 4 to create electronic image data representing the documents in analog or digital format including the raw scanned data or compressed data. Alternatively, the image data may also be created without physically scanning a document, and it may be created by converting an electronic document on a computer or other device into the image data.

The sending machine 3 transmits the electronic image data of the document over a telecommunication network 5 to another machine 6. Both the sending machine 3 and the receiving machine 6 will negotiate or establish a connection, so that the sending machine 3 may transmit the electronic image data and the receiving machine 6 may accept the electronic image data.

Negotiating (also known as electronic handshaking) requires mutual agreement of the operational modes of the machines and/or data transfer parameters, e.g., transfer rate, alphabet, parity, interrupt procedure, etc., in order to effectively communicate. These parameters are generally dictated by facsimile protocol, for example, as recommended by ITU-T or other standards organizations. For computer based faxing, which may include information transferred via email, the SMTP/MIME protocol could be used.

Terminal identification data of the sending machine 3 may be also transmitted with the facsimile, such as the telephone number and/or the name of the organization. In addition, other data (discussed below) may also be transmitted along with the facsimile image data, which may be used to classify the facsimile.

The receiving machine 6 receives the facsimile (i.e. the electronic image data transferred by the sending machine 3), and may make a printout 7 of it, transfer it to another device capable of accepting electronic image data, and/or electronically save it to memory. The machine 6 may also be configured to automatically print the facsimile, and/or save it to memory, as conventionally known.

A person (the receiver) 8 may retrieve the printout 7 of the facsimile at the receiving machine 6 (or other device, if the image data is transferred). Alternatively or in addition to printing the facsimile, the receiver 8 may open and view the facsimile image data, for example, using a software application (e.g., Adobe Acrobat®), if the recipient machine 6 has the capability to do so. The receiver 8 then can quickly determine the priority or originator of the facsimile and take appropriate action without necessarily reading the facsimile content, because the print output 7 or file data of the facsimile will be noticeable altered, as discussed below.

The receiving machine 6 classifies the facsimile based on data transmitted with the facsimile, for example, data generated by the sender 2 and/or or the sending machine 3. It is also possible to classify the facsimile at another device, if the facsimile is transferred by the receiving machine 6. In the case of computer based faxing, a fax server may transfer the facsimile as an email attachment to a mail server, recipient's computer, or other device, where classification could occur. These devices may also be referred to as a receiving machine.

A processor, either as hardware (e.g., a microprocessor) or software associated with the receiving machine 6, may be used to classify the facsimile based on data transmitted during the facsimile transfer and control the receiving machine's print output and/or altering the facsimile image data.

The classification alters the print output of the receiving machine 6 and/or the facsimile image data in accordance with a predetermined classification scheme based on the facsimile data. FIG. 2 shows how the printout 7 of the facsimile may be altered based on data transmitted with the facsimile. The image data of the facsimile may also be generated or altered electronically to include altered electronic image data (e.g., a TIFF or PDF file of the image of FIG. 2). The altered facsimile image data of the facsimile may be electronically saved in memory, transferred to other devices, opened and viewed, printed, etc.

In one embodiment, the facsimile may be printed or marked at least in part in a different color using a different colored ink or toner 9. In another embodiment, the machine 6 may select a different media 10, if the machine has the capability to recognize and feed the media type. Typical fax print media include: heavy weight, colored, punched, recycled, and/or pre-printed paper; but other media types may be also added via the machine's User Interface to identify the media in its trays. The machine can use one type of media as a default, and classify facsimiles using different media from different trays.

In another embodiment of the invention, the machine 6 may generate and/or alter the image data of the facsimile. For example, the image data of the facsimile may be transmitted in the body of an email message or attachment as an image file (e.g., a TIFF or PDF file). The image file of the facsimile may be generated or altered by the receiving machine 6 to include, in addition to the image data of the document 4, other image data, for example, different colors, decorations and/or annotations. If the image file is viewed or printed, the altered image data may also be viewed or printed.

Classifying the priority of the facsimile may be determined by using the telephone number of sending machine 3, email address of the sender 2, or other sender-supplied information including manufacturer defined-fields, which could by used specifically to support this invention. The receiving machine 6 may then alter the print output and/or image data such that, facsimiles received from a particular telephone number, number origin, or email address may be printed in a different color or media. For example, sales division telephone numbers may be printed in red, finance division telephone number may be printed in orange, and suppliers' telephone numbers may be printed in blue, etc.

In another embodiment, the classification could be determined by the priority of the facsimile. The sending machine 3 could provide an option for the sender 2 to select the urgency of the facsimile (e.g., “Very Urgent!,” “Urgent,” “Normal”) at the sending machine 3. When the facsimile is received, the print output or image data of the receiving facsimile 6 may be altered, such that “Very Urgent” is printed in red, “Urgent” is printed in orange, or “Normal” is printed according to default settings. A priority option could also be included for the sender to select in a software application for faxing. In addition, priority or classification data may be embedded as metadata or tags associated with the image data.

In yet another embodiment, the classification or priority of the facsimile may dictate the receiving machine 6 to print, and/or alter the image data to include decorative or informational annotations. For example, the facsimile print output may be altered such that facsimiles sent from the CEO's office always print out as “Urgent.”

One will appreciate that decorations and annotations could be printed or marked anywhere on the print output 7 or added electronically anywhere in the image data, as desired. The receiving machine 6 can be configured as such via the machine's User Interface or similarly by the sender 2 at sending machine 3.

A variety of decorations and annotations may be used, including, for example: a geometric shape 11 (e.g., Square, Circle, Triangle, etc.), a band 12 covering one of the edges or corners, a border 13 around at least part of the image, a custom icon 14 (e.g., $=Sales, Running man=Urgent, Truck=Suppliers, etc.), and/or text 15 (e.g., “Urgent!,” “Sales,” “FAO: Shipping,” etc.). FIG. 2 merely discloses examples of altering the print output 7 of a facsimile and electronic image data representing FIG. 2 (e.g., a TIFF or PDF file).

The method and system provide for easily classifying and prioritizing the incoming facsimile without reading the fax content.

While the specific embodiments of the present invention have been described above, it will be appreciated that the invention may be practiced otherwise than described. The description is not intended to limit the invention.

What we claim is:

1. A method for classifying and prioritizing facsimiles comprising:
accepting a facsimile comprising image data;
classifying the facsimile in accordance with a predetermined classification scheme based on the data comprising the facsimile;
determining, based on the classification, at least one characteristic of an output of the facsimile; and
outputting the facsimile in a user readable format.

2. The method of claim 1, wherein determining the at least one characteristic comprises: altering the image data of the facsimile, altering a print output of the facsimile, or both.

3. The method of claim 2, wherein altering the image data of the facsimile comprises: generating and/or altering image data corresponding to a color, decoration, annotation, or a combination thereof.

4. The method of claim 2, wherein altering the print output of the facsimile comprises at least one of the group consisting of: selecting a different media for the print output of facsimile, selecting a different color media for the print output of facsimile, printing or marking at least part of the print output of the facsimile in a different ink or toner color, and printing or marking the print output of the facsimile with a decoration or annotation.

5. The method of claim 3, wherein the decoration or annotation comprises at least one of the group consisting of: a geometric shape, a band covering an edge or corner of the facsimile, a border around at least part of the facsimile, a custom icon, and text.

6. The method of claim 4, wherein the decoration or annotation comprises at least one of the group consisting of: a geometric shape, a band covering an edge or corner of the print output of the facsimile, a border around at least part of the print output of the facsimile, a custom icon, and text.

7. The method of claim 1, wherein the data comprises at least one of the group consisting of: a telephone number of a sending machine, an email address of the sender, sender-supplied information, a manufacturer defined-field, and a user defined-field.

8. The method of claim 1, wherein classifying the facsimile is based on a priority of the facsimile.

9. The method of claim 8, wherein the priority is selected by at least one of the group consisting of: a sender, a sending machine, a receiving machine, matching a sender's telephone number with assigned priorities, and matching a sender's email address with assigned priorities.

10. The method of claim 1, further comprising:
negotiating or establishing a connection between a first machine and a second machine; and
transmitting a facsimile from the first machine to the second machine.

11. A system for classifying and prioritizing facsimiles comprising:
a machine for accepting a facsimile comprising image data;
a processor for classifying the facsimile in accordance with a predetermined classification scheme based on the data comprising the facsimile, and determining, based on the classification, at least one characteristic of an output of the facsimile; and
a device for outputting the facsimile in a user readable.

12. The system of claim 11, wherein the processor is configured to alter the image data of the facsimile, alter a print output of the facsimile, or both.

13. The system of claim 12, wherein the processor is configured to generate and/or alter image data corresponding to the at least one characteristic of an output of the facsimile comprising at least of the group consisting of: a color, a decoration, and an annotation.

14. The system of claim 12, wherein the processor is configured to select the at least one characteristic of an output of the facsimile comprising at least of the group consisting of: a different type of media, a different color media, a different ink or toner color, a decoration, and an annotation.

15. The system of claim 13, wherein the decoration or the annotation comprises at least one of the group consisting of: a geometric shape, a band covering an edge or corner of the facsimile, a border around at least part of the facsimile, a custom icon, and text.

16. The system of claim 14, wherein the decoration or annotation comprises at least one of the group consisting: a geometric shape, a band covering an edge or corner of the print output of the facsimile, a border around at least part of the print output of the facsimile, a custom icon, and text.

17. The system of claim 11, wherein the data comprises at least one of the group consisting of: a telephone number of the sending machine, an email address of the sender, sender-supplied information, a manufacturer defined-field, and a user defined-field.

18. The system of claim 11, wherein the processor classifies the facsimile based on a priority of the facsimile.

19. The system of claim 18, wherein the priority is selected by at least one of the group consisting of: a sender, a sending machine, a receiving machine, matching a sender's telephone number with assigned priorities, and matching a sender's email address with assigned priorities.

20. The system of claim 11, further comprising a machine for transmitting a facsimile.
